(19) United States
(12) Patent Application Publication
(10) Pub. No.: US 2025/0130583 A1
(43) Pub. Date: Apr. 24, 2025

(54) OPERATION SCHEDULE PLANNING SYSTEM, OPERATION SCHEDULE PLANNING APPARATUS, AND OPERATION SCHEDULE PLANNING METHOD

(71) Applicant: NEC Corporation, Minato-ku, Tokyo (JP)

(72) Inventors: Rieko UENO, Tokyo (JP); Hiromi MUTO, Tokyo (JP); Hidekazu NAGAOKA, Tokyo (JP)

(73) Assignee: NEC Corporation, Minato-ku, Tokyo (JP)

(21) Appl. No.: 18/834,271

(22) PCT Filed: Feb. 4, 2022
(86) PCT No.: PCT/JP2022/004562

§ 371 Date: Jul. 30, 2024

(51) Int. Cl. G05D 1/622; B66F 9/06; G05D 105/20; G05D 107/70

(52) U.S. Cl. CPC G05D 1/622; B66F 9/063; G05D 2105/20; G05D 2107/70

(57) ABSTRACT

In an operation schedule planning system, an operation specifying unit specifies an operation of an obstacle. A changing unit changes an order of a plurality of operation elements included in an operation schedule of a mobile object based on the operation of the obstacle. The “obstacle” means an object that may hinder the operation of the mobile object. The “mobile object” is an autonomously movable apparatus or an apparatus movable by operation of an operator, and may be, for example, a transport apparatus or a robot that transports an article or the like. The “operation of the obstacle” may be an operation accompanied by movement or an operation not accompanied by movement.

### DESCRIPTION

### Technical Field

The present disclosure relates to an operation schedule planning system, an operation schedule planning apparatus, and an operation schedule planning method.

### Background Art

Various moving bodies that can move autonomously have been developed. For example, a mobile object disclosed in Patent Literature 1 plans an operation based on, for example, a situation in which the movement of an obstacle is recognized.

### CITATION LIST

### Patent Literature

Patent Literature 1: International Patent Publication No. WO2019/116643

### SUMMARY OF INVENTION

### Technical Problem

However, in the technique disclosed in Patent Literature 1, since the movement of the mobile object is controlled each time according to the movement of the obstacle, there is a possibility that the operation efficiency of the mobile object is reduced.

An object of the present disclosure is to provide an operation schedule planning system, an operation schedule planning apparatus, and an operation schedule planning method capable of improving the operation efficiency of a mobile object.

### Solution to Problem

An operation schedule planning system according to a first aspect includes:

a specifying means for specifying an operation of an obstacle; and

a changing means for outputting a second operation schedule of a mobile object in which an order of a plurality of operation elements included in a first operation schedule of the mobile object is changed based on the operation of the obstacle.

An operation schedule planning apparatus according to a second aspect includes:

a specifying means for specifying an operation of an obstacle; and

a changing means for outputting a second operation schedule of a mobile object in which an order of a plurality of operation elements included in a first operation schedule of the mobile object is changed based on the operation of the obstacle.

An operation schedule planning method according to a third aspect includes:

specifying an operation of an obstacle; and

outputting a second operation schedule of a mobile object in which an order of a plurality of operation elements included in a first operation schedule of the first mobile object is changed based on the operation of the obstacle.

### Advantageous Effects of Invention

According to the present disclosure, it is possible to provide an operation schedule planning system, an operation schedule planning apparatus, and an operation schedule planning method capable of improving the operation efficiency of a mobile object.

### BRIEF DESCRIPTION OF DRAWINGS

FIG. 1 is a diagram illustrating an example of an operation schedule planning system according to a first example embodiment.

FIG. 2 is a diagram illustrating an example of an operation schedule planning apparatus according to the first example embodiment.

FIG. 3 is a flowchart illustrating an example of a processing operation of the operation schedule planning system and the operation schedule planning apparatus according to the first example embodiment.

FIG. 4 is a diagram for explaining an example of an operation schedule planning system according to the first example embodiment.

FIG. 5 is a view for explaining a change of an operation schedule.

FIG. 6 is a diagram illustrating an example of an operation schedule planning system according to a second example embodiment.

FIG. 7 is a diagram illustrating an example of an operation characteristic specifying unit according to the second example embodiment.

FIG. 8 is a diagram illustrating an example of a planning unit according to the second example embodiment.

FIG. 9 is a diagram for explaining determination of a risk level.

FIG. 10 is a diagram illustrating an example of an operation schedule planning apparatus according to the second example embodiment.

FIG. 11 is a flowchart illustrating an example of the processing operation of the operation schedule planning system and the operation schedule planning apparatus according to the second example embodiment.

FIG. 12 is a diagram illustrating a hardware configuration example of an operation schedule planning apparatus.

### EXAMPLE EMBODIMENT

Hereinafter, example embodiments will be described with reference to the drawings. Note that the following description and drawings are omitted and simplified as appropriate for clarity of description. Furthermore, in each of the drawings described below, the same element is denoted by the same reference numeral, and redundant description will be omitted as necessary. In addition, specific numerical values and the like shown below are only examples to facilitate understanding of the present disclosure, and are not limited thereto.

### First Example Embodiment

### <Operation Schedule Planning System>

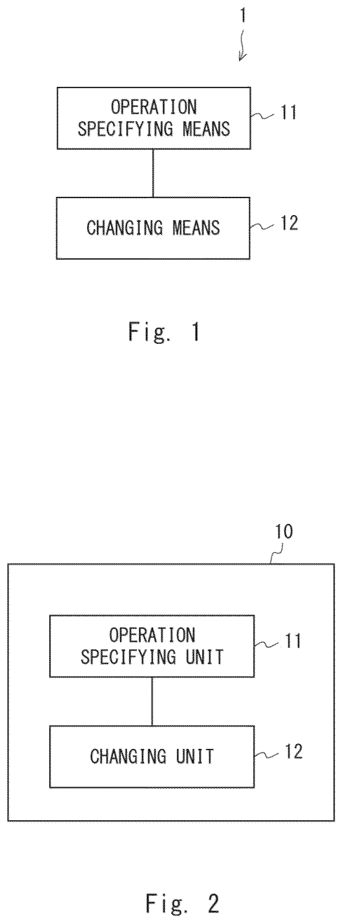

FIG. 1 is a diagram illustrating an example of an operation schedule planning system according to a first example embodiment. In FIG. 1, an operation schedule planning system 1 includes an operation specifying means 11 and a changing means 12. Note that, in the operation schedule planning system 1, the operation specifying means 11 and the changing means 12 may be provided in the same apparatus. Furthermore, the operation specifying means 11 and the changing means 12 may be provided independently of each other, and for example, may be provided on different apparatuses or on a cloud. That is, the arrangement positions of the operation specifying means 11 and the changing means 12 are not particularly limited.

The operation specifying means 11 specifies an operation of an obstacle (not illustrated).

Here, the “obstacle” means an object that may hinder the operation of the mobile object. The “obstacle” includes an object that can move and an object that cannot move. The obstacle that can move may be, for example, a person or a mobile object other than a mobile object (hereinafter, it may be referred to as a “target mobile object”) that is a target of the “operation schedule” described later. Examples of the obstacle that is not movable include an object that does not move itself, such as a load brought by another apparatus or a person, or a moved shelf. Here, a movable object will be described as an example.

The “mobile object” is an autonomously movable apparatus or an apparatus movable by operation of an operator, and may be, for example, a transport apparatus or a robot that transports an article or the like. That is, examples of the mobile object include a forklift and an automatic guided vehicle (AGV) also called an automatic guided vehicle or an automatic guided robot. In addition, the mobile object may operate by combining an autonomous operation and an operation of boarding operation or remote operation by a person, or may be remotely operated.

The “operation of the obstacle” may be an operation accompanied by movement or an operation not accompanied by movement. The information related to the specified “operation of the obstacle” may include an operation type, a position, time, or any combination thereof. For example, when the use case of the operation schedule planning system 1 is a distribution warehouse, the operation of the specified obstacle may be that a person is present three meters ahead of the mobile object, a person is walking toward the mobile object, a person is walking from the first point toward the second point, or the like.

For example, the operation specifying means 11 specifies the operation of the obstacle based on “sensing information” about the obstacle. The “sensing information” is information detected by a sensing means (not illustrated). The sensing means (not illustrated) may be, for example, a camera (RGB camera, depth camera, stereo camera, time of flight (ToF) camera, and the like), an infrared sensor, a laser sensor (2D-LiDAR (Light Detection and Ranging), 3D-LiDAR, and the like), a radar sensor, or the like. The sensing means (not illustrated) may be arranged on a mobile object (not illustrated) or may be arranged on a structure in an area where a mobile object (not illustrated) moves. For example, when the use case of the operation schedule planning system 1 is a distribution warehouse, the sensing means (not illustrated) may be arranged at a position where a location where an obstacle such as a ceiling or a beam exists in the warehouse can be overlooked. The number of sensing means (not illustrated) is not particularly limited. A plurality of sensing means (not illustrated) may be dispersedly arranged in the warehouse.

The changing means 12 changes the order of the plurality of “operation elements” included in the “operation schedule of the mobile object” based on the operation of the obstacle. The “operation schedule of the mobile object” is information that defines an operation scheduled for the mobile object. The “operation schedule of the mobile object” includes information related to a plurality of “operation elements”, and defines the content of each operation element and an order in which each operation element is performed. The “operation schedule” can also be referred to as an “operation plan”.

The “operation element” may include “operation content”, “position”, “time”, or any combination thereof. For example, when the use case of the operation schedule planning system 1 is a distribution warehouse, the operation content may be a work content. At this time, the work content includes, for example, loading work and unloading work from a truck, transporting work, picking work, and the like. Further, the “position” may be position identification information attached to each position in an area where the mobile object can move. The position identification information may be, for example, identification information of a zone into which the movable area is divided, or may be identification information of a partial zone into which the zone is divided. The “time” may be defined as any time to any time, or may be a time required from the start to the completion of the operation element.

For example, it is assumed that the operation schedule includes operation elements of “operation element 1: move to partial zone b1”, “operation element 2: perform picking work in partial zone b1”, “operation element 3: move to partial zone b5”, and “operation element 4: perform picking work in partial zone b5” in this order. In this operation schedule, it is specified to execute in the order of (operation element 1, operation element 2, operation element 3, operation element 4). Then, for example, when the operation specifying means 11 specifies that a person is walking to a position where the person moves toward the partial zone b1 of the mobile object (not illustrated), the changing means 12 may change the operation schedule so that the order is (operation element 3, operation element 4, operation element 1, operation element 2). Furthermore, for example, the changing means 12 may change the operation schedule such that the operation element at the location farthest from the location where the person is detected becomes the operation element to be executed first. Note that the changing means 12 may control the mobile object so that the moving speed of the mobile object becomes slow around the location where the person is detected.

Furthermore, for example, the changing means 12 may change the operation schedule when the operation of the obstacle specified by the operation specifying means 11 is a “predetermined operation”. The “predetermined operation” is a predetermined operation pattern, and may be, for example, “a person waving a hand toward a mobile object”. For example, in a case where it is desired to positively change the operation schedule of the mobile object, the operation schedule can be changed by shaking a hand in front of the mobile object. That is, “specification of a predetermined operation” can be used as a trigger for an operation schedule change. Furthermore, for example, the changing means 12 may cause the mobile object to issue a warning buzzer when a person is detected near the mobile object, and change the operation schedule in a case where the person does not move even after a predetermined time has elapsed from the timing when the warning buzzer was issued.

Then, the changing means 12 outputs the changed operation schedule of the mobile object. The output changed operation schedule of the mobile object may be used as an input of another functional means in the apparatus provided with the changing means 12, or may be transmitted from a transmission means (not illustrated) provided in the apparatus to another apparatus. For example, the changed operation schedule of the mobile object may be transmitted to the mobile object (not illustrated). Then, the mobile object (not illustrated) may autonomously operate based on the received changed operation schedule. Alternatively, the mobile object (not illustrated) may display the changed operation schedule on a display unit (not illustrated), and the operator may operate the mobile object by viewing the display. Furthermore, for example, the changed operation schedule of the mobile object may be transmitted to an operator apparatus (not illustrated) operated by the operator. Then, the operator may remotely operate the mobile object (not illustrated) based on the changed operation schedule of the mobile object.

### <Configuration Example of Operation Schedule Planning Apparatus>

FIG. 2 is a diagram illustrating an example of an operation schedule planning apparatus according to the first example embodiment. In FIG. 2, the operation schedule planning apparatus 10 includes an operation specifying unit 11 and a changing unit 12. That is, FIG. 2 illustrates an example in which the operation specifying means 11 and the changing means 12 are provided in the same apparatus, and the operation specifying means 11 and the changing means 12 provided in the operation schedule planning apparatus 10 are referred to as an operation specifying unit 11 and a changing unit 12. The description of the operation specifying unit 11 and the changing unit 12 overlaps with the description of the operation specifying means 11 and the changing means 12, and thus will be omitted.

The apparatus in which the operation schedule planning apparatus 10 is arranged is not particularly limited, and for example, the operation schedule planning apparatus 10 may be provided in a mobile object (not illustrated), may be provided in a management apparatus that manages the mobile object (not illustrated), or may be provided in an edge terminal (not illustrated). Specific examples will be described later.

### <Processing Operation Example>

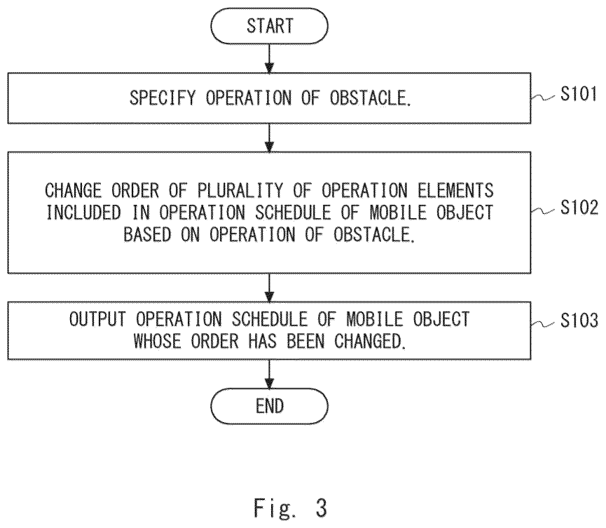

FIG. 3 is a flowchart illustrating an example of the processing operation of the operation schedule planning system and the operation schedule planning apparatus according to the first example embodiment.

The operation specifying means 11 (operation specifying unit 11) specifies an operation of an obstacle (not illustrated) (step S101).

The changing means 12 (changing unit 12) changes the order of the plurality of “operation elements” included in the “operation schedule of the mobile object” based on the operation of the obstacle (step S102).

The changing means 12 (changing unit 12) outputs the operation schedule of the mobile object whose order has been changed (step S103).

### EXAMPLES

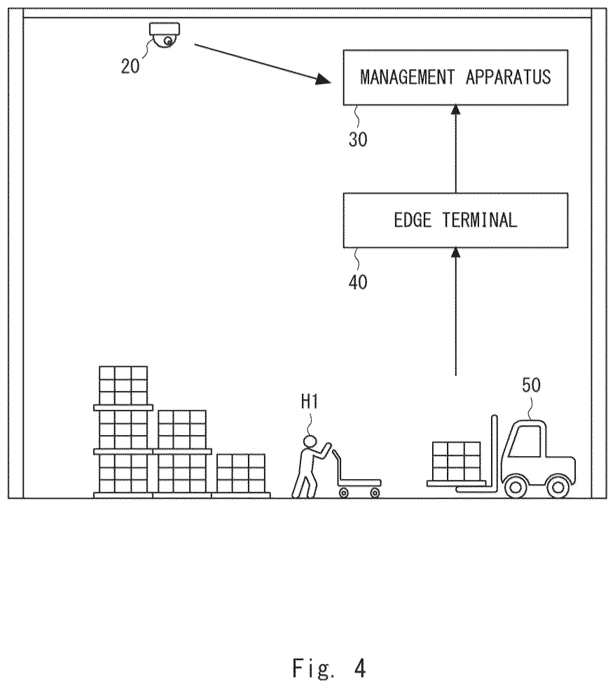

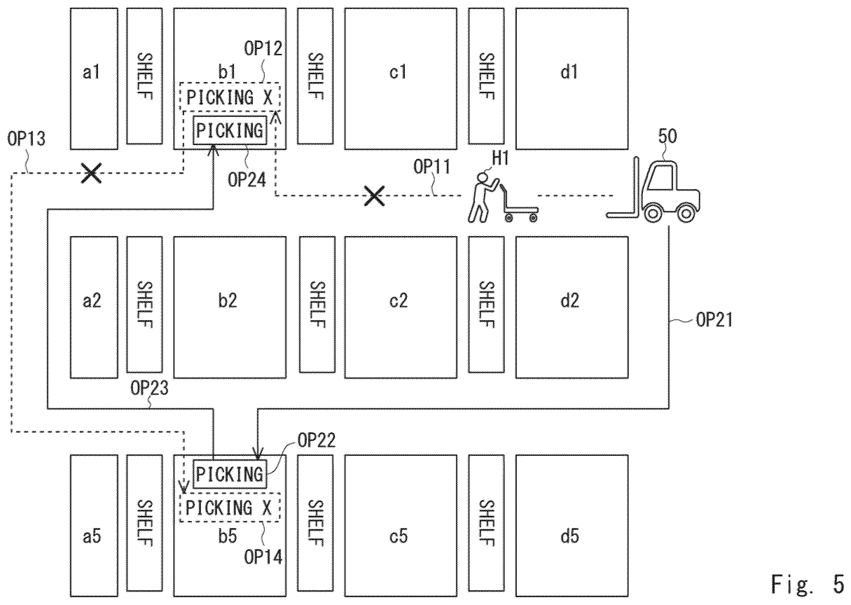

Next, an example of the operation schedule planning system according to the first example embodiment will be described. FIG. 4 is a diagram for explaining an example of the operation schedule planning system according to the first example embodiment.

FIG. 4 illustrates a management system in a warehouse as an example. In FIG. 4, the management system includes a sensor 20, a management apparatus 30, an edge terminal 40, and a mobile object (transport apparatus) 50. As described above, the apparatus in which the operation schedule planning apparatus 10 of the first example embodiment is arranged is not particularly limited, but here, a description will be given assuming that the operation schedule planning apparatus 10 is arranged in the management apparatus 30. In addition, here, a description will be given on the assumption that the mobile object 50 is a forklift as an example. The mobile object 50 includes a sensing means (not illustrated). The edge terminal 40 may collect sensing information, perform pre-processing on the collected sensing information, and transmit the sensing information to the management apparatus 30.

The sensor 20 and the sensing means (not illustrated) provided in the mobile object 50 may be, for example, a camera (RGB camera, depth camera, stereo camera, time of flight (ToF) camera, and the like), an infrared sensor, a laser sensor (2D-LiDAR (Light Detection and Ranging), 3D-LiDAR, and the like), a radar sensor, or the like. The sensor 20 and the sensing means (not illustrated) provided in the mobile object 50 may transmit sensing information to the management apparatus 30 via a network (not illustrated). Furthermore, the sensor 20 may be arranged at a position (for example, a ceiling or a beam) where a location where an obstacle exists in an area where the mobile object 50 can transport (here, the warehouse) can be overlooked. The number of sensors 20 is not particularly limited. The plurality of sensors 20 may be dispersedly arranged in the transportable area.

Here, it is assumed that the mobile object 50 autonomously operates based on the current operation schedule. It is assumed that this current operation schedule includes operation elements of “operation element 1: move to partial zone b1”, “operation element 2: perform picking work in partial zone b1”, “operation element 3: move to partial zone b5”, and “operation element 4: perform picking work in partial zone b5” in this order.

Then, it is assumed that the operation specifying means 11 specifies that the person H1 is present in the traveling direction based on the sensing information. The sensing information may be received from the sensor 20 via a network (not illustrated). The type of the network is not particularly limited, and may be, for example, a network such as 3rd generation (3G), long term evolution (LTE), 4G, 5G, or local 5G, a wireless local area network (for example, Wi-Fi (registered trademark)), a wired LAN, or a low power wide area network (LPWAN). Alternatively, the sensing information may be received from a sensing means (not illustrated) provided in the mobile object 50 via the edge terminal 40.

At this time, the changing means 12 changes the order of the operation elements so as to be the order of (operation element 3, operation element 4, operation element 1, operation element 2), thereby changing the operation schedule.

FIG. 5 is a diagram for explaining an example of a change of an operation element. An operation schedule including the operation elements (operation element 1, operation element 2, operation element 3, operation element 4) in this order is referred to as a “first operation schedule”. The operation schedule in which the order of the operation elements is changed so as to be the order of (operation element 3, operation element 4, operation element 1, and operation element 2) is referred to as a “second operation schedule”. FIG. 5 visually illustrates that the order of the operation elements of the “first operation schedule” is changed to obtain the “second operation schedule”.

In FIG. 5, the “first operation schedule” is illustrated as including operation element OP11, operation element OP12, operation element OP13, and operation element OP14 in this order. Operation element OP11 indicated by a broken line arrow means “operation element 1: move to partial zone b1”. Operation element OP12 means “operation element 2: perform picking work in partial zone b1”. Operation element OP13 indicated by a broken line arrow means “operation element 3: move to partial zone b5”. Operation element OP14 means “operation element 4: perform picking work in partial zone b5”.

In FIG. 5, when the mobile object 50 executes operation element OP11 (operation element 1: move to partial zone b1) according to the “first operation schedule”, the person H1 is located in the traveling direction of the mobile object 50. Then, the operation specifying means 11 specifies that the person Hl is present in the traveling direction based on the sensing information. At this time, the changing means 12 changes the order of the operation elements of the “first operation schedule” such that the order of operation element OP13 (operation element 3: move to partial zone b5) and operation element OP14 (operation element 4: perform picking work in partial zone b5) in which the mobile object 50 does not approach the person H1 comes before, and obtains the “second operation schedule”.

In FIG. 5, the “second operation schedule” is illustrated as including operation element OP21, operation element OP22, operation element OP23, and operation element OP24 in this order. Operation element OP21 indicated by a solid arrow means “operation element 3: move to partial zone b5”. Operation element OP22 means “operation element 4: perform picking work in partial zone b5”. Operation element OP23 indicated by a solid arrow means “operation element 1: move to partial zone b1”. Operation element OP24 means “operation element 2: perform picking work in partial zone b1”. In this way, by changing the operation order of the “first operation schedule” to obtain the “second operation schedule”, it is possible to more dynamically change the schedule, and thus, it is possible to improve the operation efficiency of the mobile object. In FIG. 5, operation element OP11, operation element OP12, operation element OP13, and operation element OP14 of the “first operation schedule” are marked with a cross mark, which means that the “first operation schedule” is canceled.

Then, the changing means 12 may notify the mobile object 50 of the changed operation schedule via the edge terminal 40. When the operation schedule planning apparatus 10 is arranged in the edge terminal 40, the changing means 12 notifies the mobile object 50 of the changed operation schedule. Furthermore, in a case where the operation schedule planning apparatus 10 is arranged in the mobile object 50, the changing means 12 may output the changed operation schedule to a control unit (not illustrated) of the mobile object 50, and the control unit (not illustrated) may control the operation of the mobile object 50 based on the changed operation schedule.

As described above, according to the first example embodiment, in the operation schedule planning system 1, the operation specifying means 11 specifies the operation of an obstacle (not illustrated). The changing means 12 changes the order of the plurality of “operation elements” included in the “operation schedule of the mobile object” based on the operation of the obstacle.

With the configuration of the operation schedule planning system 1, the order of the operation elements constituting the operation schedule of the mobile object existing at that time is changed instead of controlling the mobile object every time according to the operation of the obstacle. As a result, it is possible to more dynamically change the schedule, and thus, it is possible to improve the operation efficiency of the mobile object.

### Second Example Embodiment

The second example embodiment particularly relates to the planning of an operation schedule.

### <Operation Schedule Planning System>

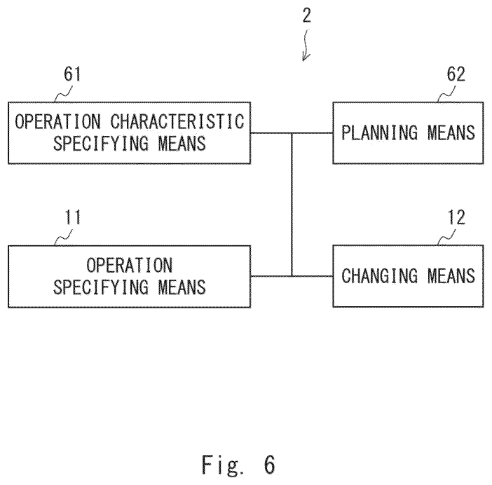

FIG. 6 is a diagram illustrating an example of an operation schedule planning system according to a second example embodiment. In FIG. 6, the operation schedule planning system 2 includes an operation specifying means 11, a changing means 12, an operation characteristic specifying means 61, and a planning means 62. Note that, in the operation schedule planning system 2, the operation specifying means 11, the changing means 12, the operation characteristic specifying means 61, and the planning means 62 may be provided in the same apparatus. In addition, the operation specifying means 11, the changing means 12, the operation characteristic specifying means 61, and the planning means 62 may be independently provided, and may be provided on different apparatuses or a cloud, for example. That is, the arrangement positions of the operation specifying means 11, the changing means 12, the operation characteristic specifying means 61, and the planning means 62 are not particularly limited.

The operation characteristic specifying means 61 specifies an operation characteristic of the target object. The “target object” is an object whose operation characteristic is to be specified, and may be, for example, a person or a mobile object other than the “target mobile object”. The “target object” is, for example, an object whose operation characteristic can be specified based on a work plan or sensing information to be described later at the time of planning an operation schedule. Note that, for example, the “obstacle” is typically an object that cannot be grasped at the time of planning the operation schedule and suddenly appears. However, a “target object” may be treated as an “obstacle”. The “operation characteristic” indicates a characteristic of an operation that is highly likely to be taken by a specified target, and can also be referred to as an “operation pattern”. The operation characteristic may include, for example, an operation type, a position, a time, or any combination thereof. The operation type is information for distinguishing an operation. The position may be an absolute position (for example, identification information of a partial zone to be described later) or a relative position (for example, a distance between the mobile object and the target object). Furthermore, the time may be defined as any time to any time, or may be a time required from the start to the completion of the operation. For example, when the use case of the operation schedule planning system 2 is a distribution warehouse, the operation characteristic specifying means 61 specifies, as the “operation characteristic”, “a person is working in the partial zone b1 and will not move for a while”, “a person is moving from the partial zone a1 toward the partial zone b1”, “the distance between the target object and the mobile object is more than 3 meters, and the target object is walking”, and the like.

For example, the operation characteristic specifying means 61 may acquire the “work schedule of the target object”, and specify the operation characteristic of the target object based on the acquired “work schedule of the target object”. The “work schedule” is information that defines a work scheduled for a target object. The “work schedule of the target object” includes information on a plurality of “work elements”, and defines the content of each work element and the order in which each work element is performed. That is, the “work schedule” can be read as a “work pattern” or a “work plan”. The “work element” may include “work content”, “position”, “time”, or any combination thereof. The “work schedule” may include identification information (for example, a worker ID or the like) of the target object. The “work content” may be, for example, picking, inspection, or the like. Further, the “position” may be position identification information attached to each position in the area. The “time” may be defined as any time to any time, or may be a time required from the start to the completion of the work element.

The worker may input the “work schedule of the target object” to the operation characteristic specifying means 61 each time, or may collectively input the work schedule at a certain timing (for example, at the time of starting work). Alternatively, a supervisor supervising a worker or overall work in the site may input work schedules of a plurality of workers to the operation characteristic specifying means 61. Alternatively, the operation characteristic specifying means 61 may collect the “work schedule of the target object” from another management system different from the management system in which the operation schedule planning system 2 is arranged.

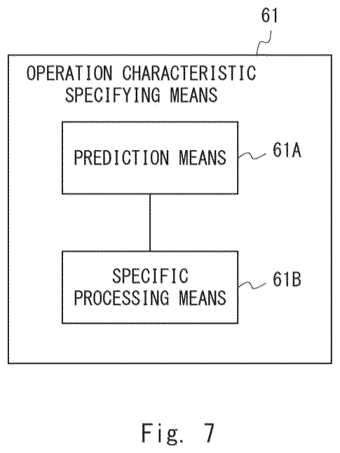

Alternatively, for example, the operation characteristic specifying means 61 may predict the operation schedule of the target object based on the sensing information detected by the sensing means (not illustrated), and specify the operation characteristic of the target object based on the predicted operation schedule. That is, as illustrated in FIG. 7, the operation characteristic specifying means 61 may include a prediction means 61A and a specific processing means 61B. Then, the prediction means 61A predicts the operation schedule of the target object based on the sensing information detected by the sensing means (not illustrated). The specific processing means 61B specifies the operation characteristic of the target object based on the predicted operation schedule. The sensing means (not illustrated) may be, for example, a camera (RGB camera, depth camera, stereo camera, time of flight (ToF) camera, and the like), an infrared sensor, a laser sensor (2D-LiDAR (Light Detection and Ranging), 3D-LiDAR, and the like), a radar sensor, or the like. The sensing means (not illustrated) may be arranged on a mobile object (not illustrated) or may be arranged on a structure in an area where a mobile object (not illustrated) moves. For example, when the use case of the operation schedule planning system 2 is a distribution warehouse, the sensing means (not illustrated) may be arranged at a position (for example, a ceiling or a beam) where a location where a target object exists in the warehouse can be overlooked. The number of sensing means (not illustrated) is not particularly limited. A plurality of sensing means (not illustrated) may be dispersedly arranged in the warehouse.

For example, in a case where the prediction means 61A recognizes that a person is moving together with a specific basket based on the sensing information, the prediction means predicts that the person is performing a picking work. When recognizing that a person is working with a specific board based on the sensing information, the prediction means 61A predicts that the person is performing inspection work. Furthermore, in a case where the prediction means 61A recognizes that a person is moving without work based on the sensing information, the prediction means predicts that the person is simply moving. In addition, the prediction means 61A may predict that the cleaning work is performed in a case where the person wears specific clothes based on the sensing information.

Returning to the description of FIG. 6, the planning means 62 plans the “operation schedule of the mobile object” based on the operation characteristic of the target object. As described above, the “operation schedule of the mobile object” is information that defines an operation scheduled for the mobile object. The “operation schedule of the mobile object” includes information related to a plurality of “operation elements”, and defines the content of each operation element and an order in which each operation element is performed. For example, when it is specified as the “operation characteristic” that “a person is working in the partial zone b1 and does not move for a while”, the planning means 62 may plan an operation schedule including an operation element of “pass through the side of the person to head to partial zone b1, and perform picking work”. In addition, for example, in a case where “a person is moving from the partial zone a1 toward the partial zone b1” is specified as the “operation characteristic”, the planning means 62 may plan an operation schedule including an operation element of “carrying out the unloading work of the partial zone c1” since there is a possibility that the mobile object comes into contact with the person when working in the partial zone b1.

For example, the planning means 62 may specify “the influence of the operation of the target object on the candidate operation of the mobile object” based on the operation characteristic of the target object, and may plan the operation schedule of the mobile object based on the specified influence. The “candidate operation” is a candidate for an operation that the mobile object can take. For example, the “candidate operation” is used as a component when an operation schedule of the mobile object is planned, and the planning means 62 plans the operation schedule of the mobile object by combining the candidate operations. Note that, in the present specification, the “candidate operation” included in the planned operation schedule of the mobile object is referred to as an “operation element”. The “influence of the operation of the target object on the candidate operation of the mobile object” is a limitation given to the candidate operation of the mobile object by the operation of the target object. For example, a degree of risk (risk level) caused by a combination of the operation of the target object and the candidate operation of the mobile object may be used as the parameter of the “influence of the operation of the target object on the candidate operation of the mobile object”.

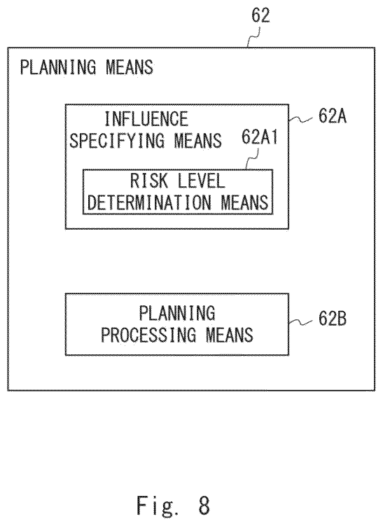

More specifically, as illustrated in FIG. 8, the planning means 62 may include an influence specifying means 62A including a risk level determination means 62A1 and a planning processing means 62B.

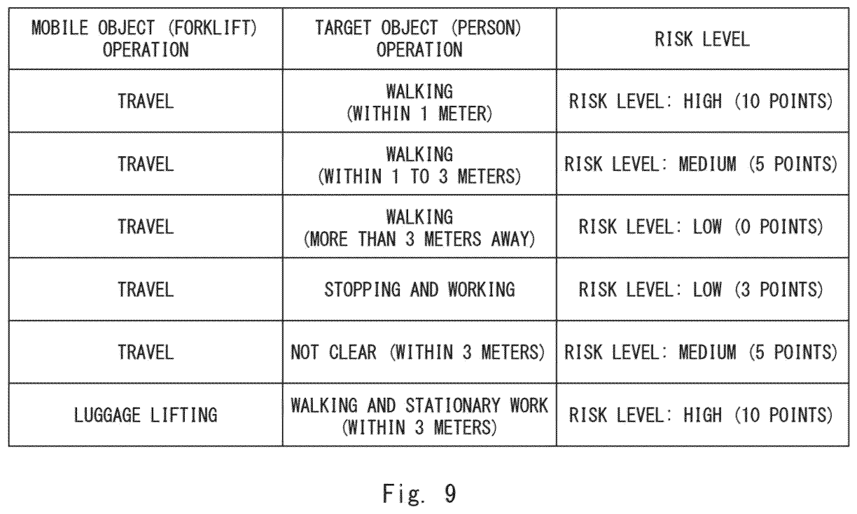

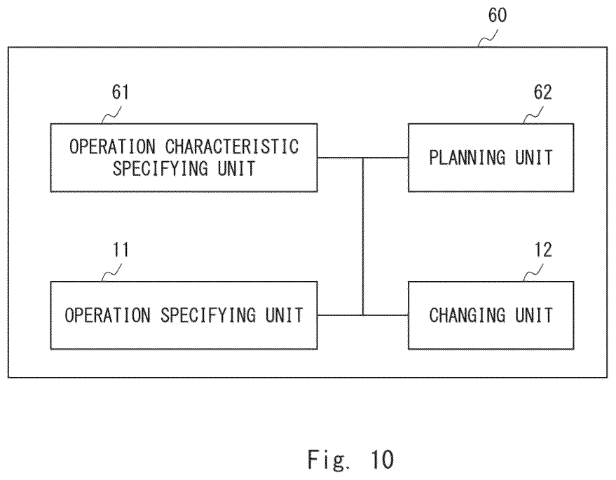

The risk level determination means 62A1 determines the risk level of each candidate operation of the mobile object based on the operation characteristic of the target object. For the determination of the risk level, for example, a “correspondence relationship” as illustrated in FIG. 9 may be used. In the correspondence relationship illustrated in FIG. 9, a combination of the operation of the target object and the candidate operation of the mobile object is associated with the risk level according to the combination. The “risk level” may be divided into levels such as high, medium, and low, or may be represented by points. Note that the correspondence relationship illustrated in FIG. 9 is merely an example, and examples of the operation of the fork of the mobile object include “rotation” in addition to “lifting”. The risk level (point) of the “rotating” operation may be set higher than that of the “lifting” operation.

The planning processing means 62B plans the operation schedule of the mobile object using the candidate operation whose determined risk level is lower than the predetermined level. For example, it is assumed that a planning criterion for planning an operation schedule using a candidate operation (for example, a candidate operation having a low risk level) having a risk level lower than a medium level is set. At this time, based on the correspondence relationship in FIG. 9, the planning processing means 62B can use the candidate operation “travel” of the mobile object for the planning of the operation schedule only when the “operation characteristic” of the target object is “the distance between the target object and the mobile object is more than 3 meters, and the target object is walking” and when the “operation characteristic” of the target object is “stopping and working”. Note that, for example, the risk level may be expressed by levels divided into high, medium, and low, or may be expressed by points (scores). For example, when a planning criterion for planning an operation schedule using candidate operations of three points or less is set, the candidate operation “travel” of the mobile object can be used for planning the operation schedule only when the “operation characteristic” of the target object is “the distance between the target object and the mobile object is more than 3 meters, and the target object is walking” and when the “operation characteristic” of the target object is “stopping and working” with reference to the correspondence relationship in FIG. 9. Note that, in FIG. 9, both a case where the risk is classified into levels and a case where the risk is expressed by points are illustrated, but in practice, both values may be used, or either one may be used.

### <Configuration Example of Operation Schedule Planning Apparatus>

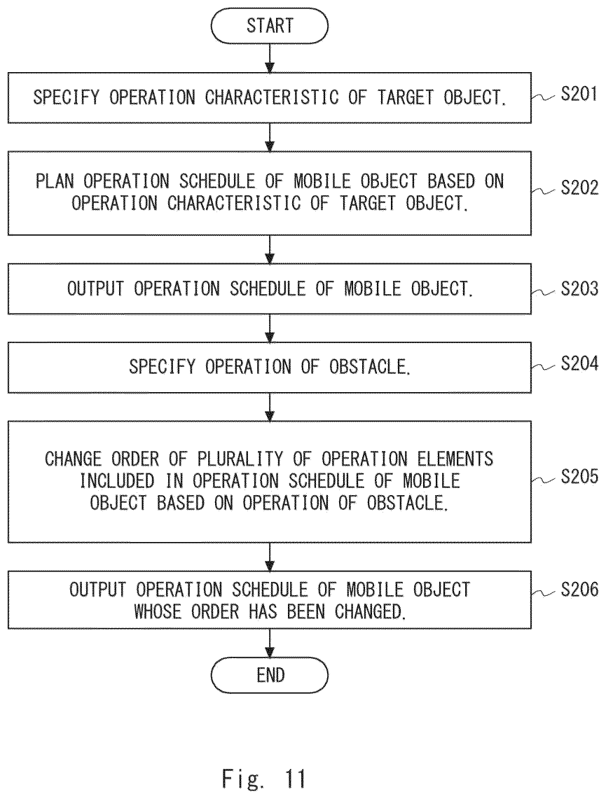

FIG. 10 is a diagram illustrating an example of the operation schedule planning apparatus according to the second example embodiment. In FIG. 10, the operation schedule planning apparatus 60 includes an operation specifying unit 11, a changing unit 12, an operation characteristic specifying unit 61, and a planning unit 62. That is, FIG. 10 illustrates an example in which the operation specifying means 11, the changing means 12, the operation characteristic specifying means 61, and the planning means 62 are provided in the same apparatus, and the operation specifying means 11, the changing means 12, the operation characteristic specifying means 61, and the planning means 62 provided in the operation schedule planning apparatus 60 are referred to as an operation specifying unit 11, a changing unit 12, an operation characteristic specifying unit 61, and a planning unit 62. The description of the operation specifying unit 11, the changing unit 12, the operation characteristic specifying unit 61, and the planning unit 62 overlaps with the description of the operation specifying means 11, the changing means 12, the operation characteristic specifying means 61, and the planning means 62, and thus will be omitted.

The apparatus in which the operation schedule planning apparatus 60 is arranged is not particularly limited, and for example, the operation schedule planning apparatus 60 may be provided in a mobile object (for example, the mobile object 50), may be provided in a management apparatus (for example, the management apparatus 30) that manages the mobile object (for example, the mobile object 50), or may be provided in an edge terminal (for example, the edge terminal 40).

### <Processing Operation Example>

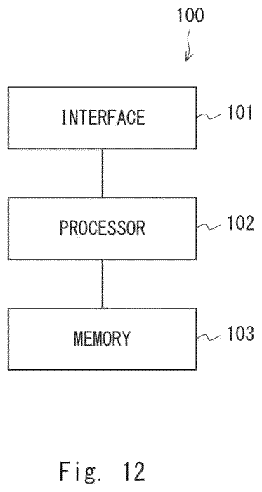

FIG. 11 is a flowchart illustrating an example of the processing operation of the operation schedule planning system and the operation schedule planning apparatus according to the second example embodiment. Here, in particular, planning of the operation schedule of the mobile object will be described.

The operation characteristic specifying means 61 (operation characteristic specification unit 61) specifies the operation characteristic of the target object (step S201).

The planning means 62 (planning unit 62) plans the operation schedule of the mobile object based on the operation characteristic of the target object (step S202).

For example, the process of specifying the operation characteristic of the target object in step S201 may include the following process.
The operation characteristic specifying means 61 (operation characteristic specification unit 61) acquires a “work schedule of the target object”.
The operation characteristic specifying means 61 (operation characteristic specifying section 61) specifies the operation characteristic of the target object based on the acquired “work schedule of the target object”.

Alternatively, the process of specifying the operation characteristic of the target object in step S201 may include the following process.
The operation characteristic specifying means 61 (operation characteristic specification unit 61) acquires sensing information detected by a sensing means (not illustrated).
The operation characteristic specifying means 61 (operation characteristic specification unit 61) predicts the operation schedule of the target object based on the sensing information.
The operation characteristic specifying means 61 (operation characteristic specification unit 61) specifies the operation characteristic of the target object based on the predicted operation schedule.

Furthermore, for example, the process of planning the operation schedule of the mobile object in step S202 may include the following process.
To specify “an influence of the operation of the target object on the candidate operation of the mobile object” based on the operation characteristic of the target object.
To plan an operation schedule of the mobile object based on the specified influence.

The above-described process of “specifying the influence of the operation of the target object on the candidate operation of the mobile object” may include a process of “determining a risk level of each candidate operation of the mobile object based on the operation characteristic of the target object” and a process of “planning the operation schedule of the mobile object using the candidate operation whose determined risk level is lower than the predetermined level”.

Then, the planning means 62 (planning unit 62) outputs the planned operation schedule of the mobile object (step S203). For example, the mobile object is notified of the operation schedule of the mobile object. Then, in a case where the mobile object that has received the operation schedule of the mobile object is autonomously operable, the mobile object starts an autonomous operation according to the operation schedule of the mobile object. In addition, in the case of the boarding type mobile object, for example, the operator operates the mobile object according to the operation schedule displayed on the display unit of the mobile object. Furthermore, the operation schedule of the mobile object may be notified to, for example, an operating apparatus (not illustrated) operated by the operator. Then, the operator may remotely operate the mobile object according to the operation schedule of the mobile object. Furthermore, as a matter of course, the mobile object may perform an operation in which the autonomous operation of the mobile object and the operation by the boarding operation or the remote operation of the person are combined.

The operation specifying means 11 (operation specifying unit 11) specifies an operation of an obstacle (not illustrated) (step S204).

The changing means 12 (changing unit 12) changes the order of the plurality of “operation elements” included in the “operation schedule of the mobile object” based on the operation of the obstacle (step S205).

The changing means 12 (changing unit 12) outputs the operation schedule of the mobile object whose order has been changed (step S206). The mobile object is notified of the operation schedule of the mobile object whose order has been changed. Then, the mobile object that has received the operation schedule of the mobile object whose order has been changed starts an operation according to the operation schedule of the mobile object whose order has been changed.

As described above, according to the second example embodiment, the operation schedule planning system 2 specifies the operation characteristic of the target object. The planning unit 62 plans an “operation schedule of the mobile object” based on the operation characteristic of the target object.

With the configuration of the operation schedule planning system 2, the operation schedule of the mobile object can be planned in consideration of the operation characteristic of the target object. For example, since the operation schedule of the mobile object can be planned in consideration of the risk caused by the combination of the operation of the target object and the candidate operation of the mobile object, it is possible to execute the safety measure that has been performed by a human sense as a system. Accordingly, safety can be improved.

### Other Example Embodiments

FIG. 12 is a diagram illustrating a hardware configuration example of the operation schedule planning apparatus. In FIG. 12, the operation schedule planning apparatus 100 includes an interface 101, a processor 102, and a memory 103. The interface 101 may be used to communicate with a network node (e.g., eNB, MME, P-GW). The interface 101 may include, for example, a network interface card (NIC) conforming to IEEE 802.3 series. Here, the eNB represents an evolved node B, the MME represents a mobility management entity, and the P-GW represents a packet data network gateway. IEEE represents Institute of Electrical and Electronics Engineers.

The processor 102 may be, for example, a microprocessor, a micro processing unit (MPU), or a central processing unit (CPU). The processor 102 may include a plurality of processors. The memory 103 is configured by a combination of a volatile memory and a nonvolatile memory. The memory 103 may include a storage located away from the processor 102. In this case, the processor 102 may access the memory 103 through an I/O interface (not illustrated).

In the example of FIG. 12, the memory 103 is used to store a software module group. The processor 102 can perform the processing of the operation schedule planning apparatus 10 and the like described in the above example embodiment by reading and executing these software module groups from the memory 103.

Each of the operation schedule planning apparatuses 10 and 60 of the first example embodiment and the second example embodiment can have the hardware configuration illustrated in FIG. 12. The operation specifying unit 11, the changing unit 12, the operation characteristic specifying unit 61, and the planning unit 62 of the operation schedule planning apparatuses 10 and 60 of the first example embodiment and the second example embodiment may be realized by the processor 102 reading and executing a program stored in the memory 103. That is, each of the processors included in the operation schedule planning apparatuses 10 and 60 executes one or a plurality of programs including a command group for causing a computer to perform the algorithm described with reference to the drawings.

The program can be stored using various types of non-transitory computer-readable media and supplied to the operation schedule planning apparatuses 10 and 60. Examples of non-transitory computer-readable media include random-access memory (RAM), read-only memory (ROM), flash memory, solid-state drive (SSD) or other memory technology, CD-ROM, digital versatile disc (DVD), Blu-ray (registered trademark) disk or other optical disk storage, magnetic cassettes, magnetic tape, magnetic disk storage, or other magnetic storage apparatuses. Furthermore, the program may be supplied to the operation schedule planning apparatuses 10 and 60 by various types of transitory computer-readable media. Examples of transitory computer-readable media include electrical signals, optical signals, and electromagnetic waves. The temporary computer-readable medium can supply the program to the operation schedule planning apparatuses 10 and 60 via a wired communication path such as an electric wire and an optical fiber or a wireless communication path.

Although the invention of the present application has been described above with reference to the example embodiments, the invention of the present application is not limited to the above. Various modifications that can be understood by those skilled in the art can be made to the configuration and details of the invention of the present application within the scope of the invention.

Some or all of the above-described example embodiments can be described as in the following supplementary notes, but are not limited to the following supplementary notes.

### (Supplementary Note 1)

An operation schedule planning system including:

a specifying means for specifying an operation of an obstacle; and

a changing means for outputting a second operation schedule of a mobile object in which an order of a plurality of operation elements included in a first operation schedule of the mobile object is changed based on the operation of the obstacle.

### (Supplementary Note 2)

The operation schedule planning system according to supplementary note 1, in which the specifying means specifies an operation of the obstacle based on sensing information regarding the obstacle.

### (Supplementary Note 3)

The operation schedule planning system according to supplementary note 1 or 2, in which the changing means changes the order of the plurality of operation elements when the operation of the obstacle is a predetermined operation.

### (Supplementary Note 4)

The operation schedule planning system according to any one of supplementary notes 1 to 3, further including:

a second specifying means for specifying an operation characteristic indicating a characteristic of an operation that is highly likely to be taken by a target object; and

a planning means for planning the first operation schedule of the mobile object based on the operation characteristic of the target object and outputting the planned first operation schedule of the mobile object.

### (Supplementary Note 5)

The operation schedule planning system according to supplementary note 4, in which the planning means includes:

a third specifying means for specifying an influence of an operation of the target object on a candidate operation of the mobile object based on the operation characteristic of the target object; and

a planning processing means for planning the first operation schedule of the mobile object including a candidate operation of the mobile object selected based on the influence as the operation element.

### (Supplementary Note 6)

The operation schedule planning system according to supplementary note 5, in which

the third specifying means includes a determination means for determining a risk level of a candidate operation of the mobile object based on the operation characteristic of the target object, and

the planning processing means plans the operation schedule of the first mobile object using a candidate operation whose determined risk level is lower than a predetermined level.

### (Supplementary Note 7)

The operation schedule planning system according to any one of supplementary notes 4 to 6, further including: a prediction means for predicting an operation of the target object based on the sensing information,

in which the second specifying means specifies the operation characteristic of the target object based on the predicted operation of the target object.

### (Supplementary Note 8)

An operation schedule planning apparatus including:

a specifying means for specifying an operation of an obstacle; and

a changing means for outputting a second operation schedule of a mobile object in which an order of a plurality of operation elements included in a first operation schedule of a mobile object is changed based on the operation of the obstacle.

### (Supplementary Note 9)

The operation schedule planning apparatus according to supplementary note 8, in which the specifying means specifies an operation of the obstacle based on sensing information regarding the obstacle.

### (Supplementary Note 10)

The operation schedule planning apparatus according to supplementary note 8 or 9, in which the changing means changes the order of the plurality of operation elements when the operation of the obstacle is a predetermined operation.

### (Supplementary Note 11)

The operation schedule planning apparatus according to any one of supplementary notes 8 to 10, further including:

a second specifying means for specifying an operation characteristic indicating a characteristic of an operation that is highly likely to be taken by a target object; and

a planning means for planning the first operation schedule of the mobile object based on the operation characteristic of the target object and outputting the planned first operation schedule of the mobile object.

### (Supplementary Note 12)

The operation schedule planning apparatus according to supplementary note 11, in which the planning means includes:

a third specifying means for specifying an influence of an operation of the target object on a candidate operation of the mobile object based on the operation characteristic of the target object; and

a planning processing means for planning the first operation schedule of the mobile object including a candidate operation of the mobile object selected based on the influence as the operation element.

### (Supplementary Note 13)

The operation schedule planning apparatus according to supplementary note 12, in which

the third specifying means includes a determination means for determining a risk level of a candidate operation of the mobile object based on the operation characteristic of the target object, and

the planning processing means plans the operation schedule of the first mobile object using a candidate operation whose determined risk level is lower than a predetermined level.

### (Supplementary Note 14)

An operation schedule planning method including:

specifying an operation of an obstacle; and

outputting a second operation schedule of a mobile object in which an order of a plurality of operation elements included in a first operation schedule of the mobile object is changed based on the operation of the obstacle.

### (Supplementary Note 15)

The operation schedule planning method according to supplementary note 14, in which the specifying of the operation of the obstacle includes specifying the operation of the obstacle based on sensing information regarding the obstacle.

### (Supplementary Note 16)

The operation schedule planning method according to supplementary note 14 or 15, in which the changing the order of the plurality of operation elements includes changing the order of the plurality of operation elements when the operation of the obstacle is a predetermined operation.

### (Supplementary Note 17)

The operation schedule planning method according to any one of supplementary notes 14 to 16, further including:

specifying an operation characteristic indicating a characteristic of an operation that is highly likely to be taken by a target object; and

planning the first operation schedule of the mobile object based on the operation characteristic of the target object, and outputting the planned first operation schedule of the mobile object.

### (Supplementary Note 18)

The operation schedule planning method according to supplementary note 17, in which the planning of the first operation schedule of the mobile object includes:

specifying an influence of an operation of the target object on a candidate operation of the mobile object based on the operation characteristic of the target object; and

planning the first operation schedule of the mobile object including a candidate operation of the mobile object selected based on the influence as the operation element.

### (Supplementary Note 19)

The operation schedule planning method according to supplementary note 18, in which

the specifying of the influence includes determining a risk level of a candidate operation of the mobile object based on the operation characteristic of the target object, and

the planning of the first operation schedule of the mobile object including the candidate operation of the mobile object selected based on the influence as the operation element includes planning the first operation schedule of the mobile object using the candidate operation whose determined risk level is lower than a predetermined level.

### (Supplementary Note 20)

The operation schedule planning method according to any one of supplementary notes 17 to 19, further including: predicting an operation of the target object based on the sensing information,

in which the specifying of the operation characteristic of the target object includes specifying an operation characteristic of the target object based on the predicted operation of the target object.

### (Supplementary Note 21)

A program for causing a computer to execute processing including:

specifying an operation of an obstacle; and

outputting a second operation schedule of a mobile object in which an order of a plurality of operation elements included in a first operation schedule of the mobile object is changed based on the operation of the obstacle.

### REFERENCE SIGNS LIST

### 1 OPERATION SCHEDULE PLANNING SYSTEM

### 2 OPERATION SCHEDULE PLANNING SYSTEM

### 10 OPERATION SCHEDULE PLANNING APPARATUS

### 11 OPERATION SPECIFYING UNIT

### 12 CHANGING UNIT

### 20 SENSOR

### 30 MANAGEMENT APPARATUS

### 40 EDGE TERMINAL

### 50 MOBILE OBJECT (TRANSPORT APPARATUS)

### 60 OPERATION SCHEDULE PLANNING APPARATUS

### 61 OPERATION CHARACTERISTIC SPECIFYING UNIT

### 61A PREDICTION UNIT

### 61B SPECIFIC PROCESSING UNIT

### 62 PLANNING UNIT

### 62A INFLUENCE SPECIFYING UNIT

### 62A1 RISK LEVEL DETERMINATION UNIT

### 62B PLANNING PROCESSING UNIT

What is claimed is:

1. An operation schedule planning system comprising:
at least one memory storing instructions, and
at least one processor configured to execute the instructions to;
specify an operation of an obstacle; and
output a second operation schedule of a mobile object in which an order of a plurality of operation elements included in a first operation schedule of the mobile object is changed based on the operation of the obstacle.

2. The operation schedule planning system according to claim 1, wherein the at least one processor is configured to execute the instructions to specify an operation of the obstacle based on sensing information regarding the obstacle.

3. The operation schedule planning system according to claim 1, wherein the at least one processor is configured to execute the instructions to change the order of the plurality of operation elements when the operation of the obstacle is a predetermined operation.

4. The operation schedule planning system according to claim 1, wherein the at least one processor is configured to execute the instructions to:
specify an operation characteristic indicating a characteristic of an operation that is highly likely to be taken by a target object; and
plan the first operation schedule of the mobile object based on the operation characteristic of the target object and outputting the planned first operation schedule of the mobile object.

5. The operation schedule planning system according to claim 4, wherein the at least one processor is configured to execute the instructions to:
specify an influence of an operation of the target object on a candidate operation of the mobile object based on the operation characteristic of the target object; and
plan the first operation schedule of the mobile object including a candidate operation of the mobile object selected based on the influence as the operation element.

6. The operation schedule planning system according to claim 5, wherein the at least one processor is configured to execute the instructions to:
determine a risk level of a candidate operation of the mobile object based on the operation characteristic of the target object, and
plan the operation schedule of the first mobile object using a candidate operation whose determined risk level is lower than a predetermined level.

7. The operation schedule planning system according to claim 4, wherein the at least one processor is configured to execute the instructions to:
predict an operation of the target object based on the sensing information, and
specify the operation characteristic of the target object based on the predicted operation of the target object.

8. An operation schedule planning apparatus comprising:
at least one memory storing instructions, and
at least one processor configured to execute the instructions to;
specify an operation of an obstacle; and
output a second operation schedule of a mobile object in which an order of a plurality of operation elements included in a first operation schedule of the mobile object is changed based on the operation of the obstacle.

9. The operation schedule planning apparatus according to claim 8, wherein the at least one processor is configured to execute the instructions to specify an operation of the obstacle based on sensing information regarding the obstacle.

10. The operation schedule planning apparatus according to claim 8, wherein the at least one processor is configured to execute the instructions to change the order of the plurality of operation elements when the operation of the obstacle is a predetermined operation.

11. The operation schedule planning apparatus according to claim 8, wherein the at least one processor is configured to execute the instructions to:
specify an operation characteristic indicating a characteristic of an operation that is highly likely to be taken by a target object; and
plan the first operation schedule of the mobile object based on the operation characteristic of the target object and outputting the planned first operation schedule of the mobile object.

12. The operation schedule planning apparatus according to claim 11, wherein the at least one processor is configured to execute the instructions to:
specify an influence of an operation of the target object on a candidate operation of the mobile object based on the operation characteristic of the target object; and
plan the first operation schedule of the mobile object including a candidate operation of the mobile object selected based on the influence as the operation element.

13. The operation schedule planning apparatus according to claim 12, wherein the at least one processor is configured to execute the instructions to:
determine a risk level of a candidate operation of the mobile object based on the operation characteristic of the target object, and
plan the operation schedule of the first mobile object using a candidate operation whose determined risk level is lower than a predetermined level.

14. An operation schedule planning method comprising:
specifying an operation of an obstacle; and
outputting a second operation schedule of a mobile object in which an order of a plurality of operation elements included in a first operation schedule of the mobile object is changed based on the operation of the obstacle.

15. The operation schedule planning method according to claim 14, wherein the specifying of the operation of the obstacle includes specifying the operation of the obstacle based on sensing information regarding the obstacle.

16. The operation schedule planning method according to claim 14, wherein the changing the order of the plurality of operation elements includes changing the order of the plurality of operation elements when the operation of the obstacle is a predetermined operation.

17. The operation schedule planning method according to claim 14, further comprising:
specifying an operation characteristic indicating a characteristic of an operation that is highly likely to be taken by a target object; and
planning the first operation schedule of the mobile object based on the operation characteristic of the target object, and outputting the planned first operation schedule of the mobile object.

18. The operation schedule planning method according to claim 17, wherein the planning of the first operation schedule of the mobile object includes:
specifying an influence of an operation of the target object on a candidate operation of the mobile object based on the operation characteristic of the target object; and
planning the first operation schedule of the mobile object including a candidate operation of the mobile object selected based on the influence as the operation element.

19. The operation schedule planning method according to claim 18, wherein
the specifying of the influence includes determining a risk level of a candidate operation of the mobile object based on the operation characteristic of the target object, and
the planning of the first operation schedule of the mobile object including the candidate operation of the mobile object selected based on the influence as the operation element includes planning the first operation schedule of the mobile object using the candidate operation whose determined risk level is lower than a predetermined level.

20. The operation schedule planning method according to claim 17, further comprising: predicting an operation of the target object based on the sensing information,
wherein the specifying of the operation characteristic of the target object includes specifying an operation characteristic of the target object based on the predicted operation of the target object.
